(19) United States
(12) Patent Application Publication
(10) Pub. No.: US 2026/0328309 A1
(43) Pub. Date: Oct. 22, 2026

(54) GAS APPLIANCE CONTROL SYSTEM AND METHOD

(71) Applicant: Michael Beckert, Atlanta, GA (US)

(72) Inventor: Michael Beckert, Atlanta, GA (US)

(21) Appl. No.: 19/567,455

(22) Filed: Mar. 16, 2026

Related U.S. Application Data
(60) Provisional application No. 63/789,696, filed on Apr. 16, 2025.

(51) Int. Cl. F16K 31/06; F17D 3/01; F23N 5/24; G05B 15/02; H04W 4/80

(52) U.S. Cl. CPC F16K 31/0675; F17D 3/01; F23N 5/242; G05B 15/02; H04W 4/80; F23N 2223/04; F23N 2223/38; F23N 2223/50

(57) ABSTRACT

Various implementations include a gas appliance control system. The system includes a valve assembly, a central control unit, and at least one user interface device. The valve assembly is configured to regulate gas flow to a gas appliance. The central control unit is operatively connected to the valve assembly and is configured to manage a flow state of the valve assembly. The at least one user interface device is configured to communicate with the central control unit to control the flow state of the valve assembly.

### BACKGROUND

Many households utilize gas appliances for heat generation, such as stoves, ovens, furnaces, heaters, and gas logs. While these devices typically provide safe and efficient heat for cooking or climate control, there are instances where gas appliances may be misused, either intentionally or unintentionally, creating unsafe conditions or uncontrolled fires. Such misuse can result in personal injury or property damage, particularly when carried out by individuals lacking proper training or mental capacity to operate gas appliances safely, such as children or elderly individuals with cognitive impairments.

For example, consider a typical gas stove with an oven. The burner and igniter control knobs are often located on the appliance's front, horizontal face. While this placement is convenient for adult users, providing easy access away from hot areas without occupying cooking space, it also makes the controls readily accessible to young children who lack proper training. Some existing safety devices attempt to prevent unauthorized access by making the knobs more difficult to operate or partially immobilizing them. However, these solutions present challenges, such as being difficult to universally implement due to varying knob designs across manufacturers, creating inconvenience for authorized users, and, most critically, not addressing the fundamental hazard-the gas supply itself.

Thus, there is a need for a more effective, convenient, and universally applicable approach to preventing fires and other hazards associated with unauthorized access and misuse of gas appliances.

### SUMMARY

Various implementations include a gas appliance control system. The system includes a valve assembly, a central control unit, and at least one user interface device. The valve assembly is configured to regulate gas flow to a gas appliance. The central control unit is operatively connected to the valve assembly and is configured to manage a flow state of the valve assembly. The at least one user interface device is configured to communicate with the central control unit to control the flow state of the valve assembly.

In some implementations, the valve assembly includes a solenoid valve. In some implementations, the solenoid valve is configured to maintain a current state when de-energized. In some implementations, the solenoid valve is configured to be normally closed when de-energized. In some implementations, the central control unit is configured to detect a change in power and place the valve assembly in a predetermined state.

In some implementations, the central control unit is programmed to execute a control algorithm for managing the flow state of the valve assembly.

In some implementations, the at least one user interface device includes a mobile device running a dedicated application. In some implementations, the central control unit is configured to cause the valve assembly to regulate gas flow to a predetermined flow state when the central control unit determines that the at least one user interface device is within a predetermined proximity to the central control unit. In some implementations, the dedicated application is configured to communicate with the central control unit via a wireless communication protocol. In some implementations, the wireless communication protocol is Bluetooth.

In some implementations, the system includes a wired control switch connected to the central control unit. In some implementations, the wired control switch is configured to provide manual control of the valve assembly.

In some implementations, the central control unit is configured to receive user authentication before allowing control of the valve assembly.

In some implementations, the central control unit is configured to implement a scheduling feature for automatically controlling the flow state of the valve assembly.

In some implementations, the system includes a backup battery for maintaining operation during a power outage.

In some implementations, the central control unit is configured to monitor gas flow through the valve assembly. In some implementations, the central control unit is configured to generate an alert if abnormal gas flow is detected.

Various other implementations include a gas appliance control system. The system includes a valve assembly configured to regulate gas flow to a gas appliance, a user interface device configured to transmit gas flow requests, and a central control unit. The central control unit is operatively connected to the valve assembly and the user interface device. The central control unit is configured to receive a gas flow request from the user interface device, determine whether the gas flow request is authorized, and control the valve assembly to regulate gas flow to the gas appliance based on the determination.

In some implementations, the user interface device is a mobile device running a dedicated application. In some implementations, the central control unit is configured to cause the valve assembly to regulate gas flow to a predetermined flow state when the central control unit determines that the at least one user interface device is within a predetermined proximity to the central control unit. In some implementations, the dedicated application is configured to communicate with the central control unit via a wireless communication protocol. In some implementations, the wireless communication protocol is Bluetooth.

In some implementations, the central control unit is further configured to authenticate a user before allowing control of the valve assembly.

In some implementations, the central control unit is further configured to implement a scheduling feature for automatically controlling the flow state of the valve assembly.

In some implementations, the central control unit is further configured to monitor gas flow through the valve assembly. In some implementations, the central control unit is further configured to generate an alert if abnormal gas flow is detected.

In some implementations, the central control unit is further configured to detect a change in power and place the valve assembly in a predetermined state.

In some implementations, the valve assembly includes a solenoid valve. In some implementations, the solenoid valve is configured to be normally closed when de-energized.

In some implementations, the system includes a wired control switch connected to the central control unit. In some implementations, the wired control switch is configured to provide manual control of the valve assembly.

In some implementations, the central control unit includes a memory configured to store user preferences for gas flow control. In some implementations, the central control unit includes a memory configured to log gas flow control actions. In some implementations, the central control unit is configured to provide feedback to the user interface device regarding the current flow state of the valve assembly.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a system diagram view of a gas appliance control system, according to one implementation.

FIG. 2 is a perspective view of the gas appliance control system shown in FIG. 1.

FIG. 3 is a perspective view of the components of the gas appliance control system shown in FIG. 2.

FIG. 4 is a front view of a mobile application interface for the gas appliance control system shown in FIG. 1.

FIG. 5 is a front view of a settings interface screen for the gas appliance control system shown in FIG. 1.

### DETAILED DESCRIPTION

The devices, systems, and methods disclosed herein provide for a gas appliance control system designed to enhance safety and prevent unauthorized or unintended use of gas appliances. This system provides a more effective, convenient, and universally applicable approach to preventing fires associated with unauthorized access and misuse of gas-powered appliances, such as stoves, ovens, furnaces, or water heaters. In various embodiments, a device is disclosed that directly and proactively controls the gas supply to an appliance. By managing the gas supply, the risk of uncontrolled fire is significantly reduced, as combustion cannot occur without fuel.

In one aspect, a system of hardware and software elements is provided that only allows gas to flow to a connected appliance under conditions deemed appropriate by an authorized user. If such conditions are not met, then the system restricts or completely stops the flow of gas to the connected appliance, thereby preventing some or all of the appliance's normal operations.

In some cases, the gas appliance control system may comprise multiple components working in conjunction to manage gas flow. These components may include a valve assembly, a user interface device, and a central control unit. The valve assembly may be located between the appliance to be protected and the source of combustible gas and be configured to regulate the flow of gas to the connected appliance. The appliance operates normally when the valve is open, but when the valve is closed and/or is restricting the flow of gas, the appliance is incapable of operating normally or at normal capacity (e.g., cannot create and/or sustain combustion or generating heat). In alternative embodiments, the valve may only restrict gas flow such that some normal appliance operations are possible (such as sustaining a pilot light) while others are not (such as igniting and/or sustaining burners).

The central control unit is operatively connected to the valve and manages the valve's flow state. The user interface device may allow users to interact with the system and input commands. The central control unit may serve as the brain of the system, processing user inputs and controlling the valve assembly accordingly. The central control unit may receive user input from the user interface device or a variety of sources with the aim of controlling the valve's flow state in response to user requests for gas flow. Such authorized sources may include wireless communication with a multitude of user peripheral devices and/or direct wired communications. The central control unit or connected peripheral devices may include scheduling features to manage the flow state of the valve.

The gas appliance control system may offer various benefits, including improved safety measures, remote control capabilities, and customizable settings to suit different user needs. By providing a means to regulate gas flow, the system may help prevent accidents, reduce the risk of gas leaks, and offer peace of mind to users.

In some cases, the system may incorporate both hardware and software elements to create a comprehensive solution for gas appliance control. This integration may allow for advanced features such as scheduling, user authentication, and monitoring of gas usage patterns.

The gas appliance control system may be designed with flexibility in mind, potentially allowing for installation on a wide range of gas appliances and accommodating various user preferences and safety requirements.

Various implementations include a gas appliance control system. The system includes a valve assembly, a central control unit, and at least one user interface device. The valve assembly is configured to regulate gas flow to a gas appliance. The central control unit is operatively connected to the valve assembly and is configured to manage a flow state of the valve assembly. The at least one user interface device is configured to communicate with the central control unit to control the flow state of the valve assembly.

Various other implementations include a gas appliance control system. The system includes a valve assembly configured to regulate gas flow to a gas appliance, a user interface device configured to transmit gas flow requests, and a central control unit. The central control unit is operatively connected to the valve assembly and the user interface device. The central control unit is configured to receive a gas flow request from the user interface device, determine whether the gas flow request is authorized, and control the valve assembly to regulate gas flow to the gas appliance based on the determination.

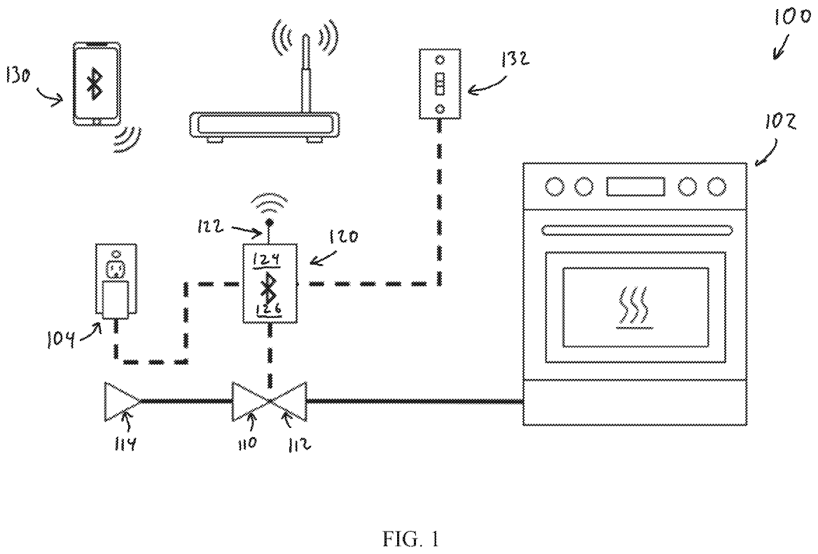

FIGS. 1-3 show a gas appliance control system 100 with aspects included in various implementations. The system 100 includes a valve assembly 110, a central control unit 120, and at least one user interface device 130.

The valve assembly 110 is configured to regulate gas flow to a gas appliance 102. As shown in FIG. 1, the valve assembly 110 is positioned between the gas supply source and the appliance 102. FIG. 2 illustrates a detailed view of the valve assembly 110 integrated into the gas supply line 114.

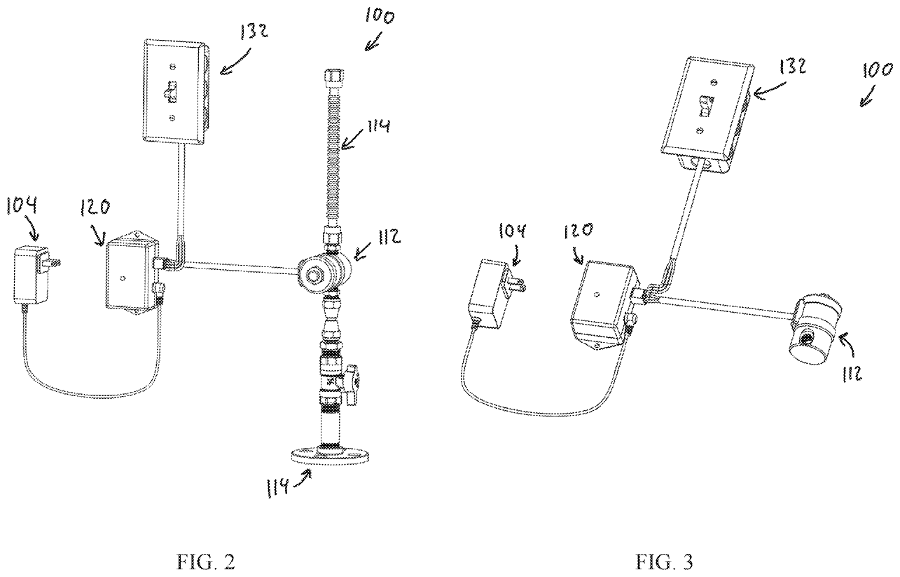

The valve assembly 110 comprises a flow control valve 112 suitable for controlling gas flow. As depicted in FIG. 3, the valve assembly 110 includes a magnetically latching solenoid valve. This valve 112 uses permanent magnets to hold the valve in either an open or closed position, requiring electrical power only to switch between states.

The valve assembly 110 is designed to provide complete shut-off of gas flow when closed. In some implementations, the valve 112 may be configured to only restrict gas flow such that some normal appliance operations are possible while others are not. For example, the valve 112 may allow enough gas flow to sustain a pilot light but not enough to ignite or sustain main burners.

The valve assembly 110 utilizes a magnetic latching mechanism as shown in FIG. 3. In some implementations, the valve assembly 110 may use alternative actuation mechanisms. For instance, the valve 112 may use a traditional solenoid. A solenoid valve may utilize an electromagnetic coil to actuate a plunger, which can open or close the gas flow path.

In some implementations, an electric motor may be used to actuate the valve 112. An electric motor-driven valve may provide precise control over the degree of valve opening, potentially allowing for more nuanced gas flow regulation.

The valve assembly 110 is designed to integrate seamlessly with the existing gas supply infrastructure 114 of an appliance 102. As shown in FIG. 2, the valve assembly 110 includes appropriate fittings and connections to ensure proper installation and leak-free operation.

In some implementations, the valve assembly 110 may incorporate additional features such as flow sensors or pressure regulators to enhance its functionality and safety capabilities. These additional components may work in conjunction with the main valve 112 to provide more comprehensive gas flow management.

The specific configuration and capabilities of the valve assembly 110 are designed to accommodate the requirements of the particular gas appliance 102 shown in FIG. 1. In some implementations, the valve assembly 110 may be designed to accommodate a range of gas types and flow rates, ensuring compatibility with various appliance types and gas supply systems.

The central control unit 120 is operatively connected to the valve assembly 110. The central control unit 120 is configured to manage a flow state of the valve assembly 110. As shown in FIG. 1, the central control unit 120 is positioned between the user interface devices 130 and the valve assembly 110, serving as the primary control hub for the system 100.

The central control unit 120 comprises various components to facilitate its operation. As illustrated in FIG. 3, the central control unit 120 includes communication interfaces 122 for connecting to other system components. In some implementations, the central control unit 120 may include a processor 124 and memory 126. The processor 124 may execute control algorithms for managing the flow state of the valve assembly 110 based on user inputs and system parameters. The memory 126 may store user preferences, system settings, and log gas flow control actions for future reference or analysis.

FIG. 3 illustrates a detailed view of the central control unit 120 and its connections to other system components. The central control unit 120 is connected to a 12 VDC power supply 104, which provides the necessary electrical power for operation. In some implementations, the central control unit 120 may be powered by AC grid power or use batteries as a backup power source to maintain operation during power outages.

The central control unit 120 executes various functions related to gas flow management. In some implementations, the central control unit 120 may be configured to monitor gas flow through the valve assembly 110. This monitoring capability may allow the system 100 to detect abnormal gas flow patterns and generate alerts if necessary.

The central control unit 120 is designed to handle power-related events. As shown in FIG. 5, the system 100 includes settings for “Power Loss Valve Action” and “Power Return Valve Action.” In some implementations, these features may help ensure safety in the event of unexpected power outages by placing the valve assembly 110 in a predetermined state.

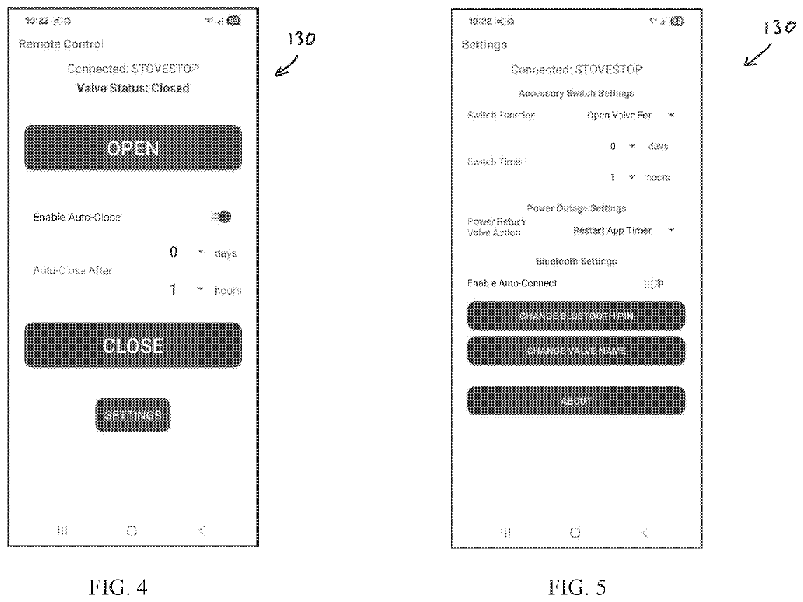

The central control unit 120 implements advanced features to enhance user control and system functionality. As illustrated in FIG. 4 and FIG. 5, the system 100 includes a scheduling feature for automatically controlling the flow state of the valve assembly 110. This scheduler or timer controls when or for how long gas flow to a connected appliance 102 is permitted, allowing users to set specific times for gas availability.

Security features are incorporated into the central control unit's 120 functionality. As shown in FIG. 5, the system 100 includes options to change the Bluetooth PIN, which helps prevent unauthorized access to the gas control system 100, enhancing overall safety.

The central control unit 120 utilizes memory capabilities for various purposes. As evident from the interface in FIG. 5, the system 100 stores user preferences for gas flow control. These preferences include valve states, scheduling preferences, and power outage settings. In some implementations, the memory 126 may be used to log gas flow control actions, providing a record of system activity that may be useful for troubleshooting or usage analysis.

The central control unit 120 is designed to interface with multiple user input devices and peripheral components. As shown in FIG. 3, the central control unit 120 connects to a wired switch 132, allowing for manual control of the valve assembly 110. The central control unit 120 also communicates with wireless devices, such as smartphones or tablets, through Bluetooth communication as illustrated in FIG. 1 and FIG. 4.

The central control unit 120 is programmed to adapt to various scenarios and user needs. As shown in FIG. 4 and FIG. 5, the control algorithms executed by the central control unit 120 consider factors such as time durations and user-defined settings when managing the flow state of the valve assembly 110. In some implementations, this adaptive capability may allow the system 100 to provide more intelligent and context-aware gas flow management based on additional factors such as time of day, user presence, or external environmental conditions.

The user interface devices 130 are configured to communicate with the central control unit 120 to control the flow state of the valve assembly 110. These user interface devices 130 provide users with various means of interacting with and controlling the system 100.

One type of user interface device 130 is a mobile device running a dedicated application. As shown in FIG. 4, the dedicated application provides a graphical user interface for controlling the gas flow. The application displays the current connection and flow status at the top of the screen. Users interact with the application through control buttons labeled “OPEN” and “CLOSE.” The “OPEN” feature allows users to set a specific duration for which the gas valve stays open, with time selection fields for days and hours.

The dedicated application communicates with the central control unit 120 via Bluetooth wireless communication. This allows for secure, short-range communication between the mobile device and the central control unit 120. In some implementations, the central control unit can communicate with wireless devices through other wireless protocols such as Thread or Wi-Fi.

The system may incorporate an “auto-connect” feature that allows authorized user devices to automatically establish a connection with the central control unit when in range. As shown in FIG. 5, this feature can be enabled or disabled through the mobile application settings. When activated, the auto-connect functionality may significantly reduce the number of steps required for users to control the gas flow, enhancing convenience and user experience. This streamlined connection process may allow users to quickly access the control interface and make adjustments to the gas flow state without manually initiating the connection each time they wish to interact with the system. In some implementations, the auto-connect feature may utilize device recognition protocols to ensure that only pre-authorized devices can automatically connect to the central control unit, maintaining system security while improving ease of use.

In some implementations, the central control unit 120 is configured to cause the valve assembly 110 to regulate gas flow to a predetermined flow state when the central control unit 120 determines that the at least one user interface device 130 is within a predetermined proximity to the central control unit 120. This proximity-based control feature leverages the Bluetooth communication capabilities shown in FIG. 1 and FIG. 4 to automatically adjust the gas flow based on the physical presence of an authorized user interface device 130, such as a mobile device. For example, the system 100 may be configured to automatically open the valve 112 when an authorized mobile device comes within Bluetooth range of the central control unit 120, and automatically close the valve 112 when all authorized mobile devices leave the predetermined proximity range. This feature enhances both convenience and safety by ensuring that gas flow is only enabled when authorized users are physically present.

FIG. 5 illustrates examples of additional settings and features available through the mobile application. The application includes an auto-connect feature that can be enabled or disabled through a toggle switch in the Bluetooth Settings section of the application.

The mobile application also provides options for changing the Bluetooth PIN and valve name. Users can access these options through dedicated buttons in the Bluetooth Settings section of the application interface.

In addition to wireless control through mobile devices, the system 100 includes a wired control switch 132 connected to the central control unit 120. This wired control switch 132 provides manual control of the valve assembly 110. As shown in FIG. 1, a wired switch 132 is directly connected to the central control unit 120, offering an alternative method of controlling the gas flow.

The wired control switch 132 has configurable operational modes, which can be set through the mobile application. As seen in FIG. 5, users can set the “Switch Function” and “Switch Timer” controls. These settings determine how the wired switch 132 behaves when activated.

In some implementations, the system 100 may provide users with the ability to enable or disable the manual wired control switch 132. This feature can enhance control over access to the gas appliance 102. Through the mobile application interface, users may have the option to activate or deactivate the wired switch 132 functionality. When disabled, the wired switch 132 may not respond to physical interactions, effectively preventing manual override of the system's settings. This capability can be particularly useful in scenarios where users want to restrict unauthorized access to the gas flow controls. For instance, in households with young children or in commercial settings where limited personnel should have control over the gas supply. By disabling the wired switch 132, users can ensure that gas flow control is only possible through authorized methods, such as the mobile application. This feature, when combined with other security measures like PIN protection for the mobile app, may allow users to implement a more comprehensive access control strategy for the gas appliance 102.

In some implementations, authorization for controlling the system 100 may include physical interactions with the central control unit 120, such as operating switches or pressing buttons. This may provide an additional layer of security, ensuring that only users with physical access to the system 100 can make certain changes or override settings.

The user interface devices 130 offer various control options. The system 100 has an “Open” mode that opens the gas valve for a set duration. This feature is accessible through both the mobile application and the wired switch 132, depending on the configuration.

In some implementations, the central control unit 120 may be designed to handle multiple user interface devices 130 simultaneously. This may allow for flexible control options, where users can interact with the system 100 through their preferred method, whether it be a mobile device 134 or a physical switch 132.

The user interface devices 130 provide feedback to users about the current state of the system 100. The mobile application displays the current flow status and connection status, as shown in FIG. 4. This real-time information helps users make informed decisions about gas flow control.

The system 100 may provide various types of feedback regarding the valve flow state to enhance user awareness and safety. In some implementations, the mobile application may display visual alerts or notifications to inform users about changes in the valve status or potential issues. These alerts may appear as pop-up messages or color-coded indicators within the application interface. Additionally, the central control unit 120 may include a visual indicator LED that changes color or blinks in different patterns to reflect the current flow state of the valve assembly 110. For instance, a steady green light may indicate an open valve, while a red light may signify a closed valve. In some cases, the central control unit 120 may incorporate an auditory feedback mechanism, such as a buzzer or small speaker, to emit distinct tones or beeps corresponding to different valve states or system events. This multi-modal feedback approach may help ensure that users can easily monitor and verify the gas flow status through various means, enhancing overall system usability and safety.

The gas appliance control system 100 integrates the valve assembly 110, central control unit 120, and user interface devices 130 to provide comprehensive control over gas flow to an appliance 102. As shown in FIG. 1, this integration allows for various operational scenarios and enhances the system's flexibility and safety features.

The central control unit 120 serves as the primary interface between the user interface devices 130 and the valve assembly 110. As illustrated in FIG. 3, when a user initiates a command through the mobile application or the wired switch 132, the central control unit 120 processes this input and sends appropriate signals to the valve assembly 110 to adjust the gas flow state.

For example, as shown in FIG. 4, if a user selects the “OPEN” option on the mobile application, the central control unit 120 receives this command via Bluetooth wireless communication. The central control unit 120 then sends a signal to the valve assembly 110 to open the valve 112 and allow gas flow to the appliance 102. Similarly, if a user activates the wired switch 132 shown in FIG. 3 to close the valve, the central control unit 120 processes this input and sends a closure signal to the valve assembly 110.

The system 100 is designed to handle various power-related scenarios. As shown in FIG. 5, the central control unit 120 is programmed with different power outage settings. After a power loss, when power is restored, the system 100 has a ‘Restart App Timer’ option. In some implementations, for power loss situations, the system 100 can have a ‘No change’option, where the valve 112 remains in its current state.

In some implementations, the system 100 may further comprise a backup battery 106. This backup battery 106 may maintain operation of critical components, such as the central control unit 120 and valve assembly 110, during periods of power loss. The inclusion of a backup power source may ensure that the gas flow can still be controlled even when the main power supply is interrupted, providing an additional layer of safety and functionality.

The integration of these components allows for advanced operational scenarios. As shown in FIG. 4, the system 100 can be programmed to automatically close the valve 112 after a predetermined period using the “OPEN” option, selecting “Enable Auto-Close,” and setting a number of days and hours for the “Auto-Close After” option. This feature serves as a safety measure to prevent prolonged, unattended gas flow.

The system 100 utilizes information from multiple sources to make decisions about gas flow. As illustrated in FIG. 1 and FIG. 3, the central control unit 120 considers inputs from both the mobile application and the wired switch 132 when determining the appropriate valve state. This multi-input approach provides users with flexible control options while maintaining system integrity.

The system integration allows for remote monitoring and control capabilities. As shown in FIG. 4, users can check the current gas flow status and adjust settings through their mobile devices 134. This feature is particularly useful for ensuring that gas flow is properly managed when users are away from home or in emergency situations.

By integrating these various components, the gas appliance control system 100 provides a comprehensive solution for managing gas flow to appliances, offering both convenience and enhanced safety features.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A gas appliance control system, the system comprising:
a valve assembly configured to regulate gas flow to a gas appliance;
a central control unit operatively connected to the valve assembly and configured to manage a flow state of the valve assembly; and
at least one user interface device configured to communicate with the central control unit to control the flow state of the valve assembly.

2. The system of claim 1, wherein the valve assembly comprises a solenoid valve.

3. The system of claim 2, wherein the solenoid valve is configured to maintain a current state when de-energized.

4. The system of claim 1, wherein the central control unit is configured to detect a change in power and place the valve assembly in a predetermined state.

5. The system of claim 1, wherein the central control unit is programmed to execute a control algorithm for managing the flow state of the valve assembly.

6. The system of claim 1, wherein the at least one user interface device comprises a mobile device running a dedicated application.

7. The system of claim 1, wherein central control unit is configured to cause the valve assembly to regulate gas flow to a predetermined flow state when the central control unit determines that the at least one user interface device is within a predetermined proximity to the central control unit.

8. The system of claim 6, wherein the dedicated application is configured to communicate with the central control unit via a wireless communication protocol.

9. The system of claim 8, wherein the wireless communication protocol is Bluetooth.

10. The system of claim 1, further comprising a wired control switch connected to the central control unit, wherein the wired control switch is configured to provide manual control of the valve assembly.

11. The system of claim 1, wherein the central control unit is configured to receive user authentication before allowing control of the valve assembly.

12. The system of claim 1, wherein the central control unit is configured to implement a scheduling feature for automatically controlling the flow state of the valve assembly.

13. The system of claim 1, further comprising a backup battery for maintaining operation during a power outage.

14. The system of claim 1, wherein the central control unit is configured to monitor gas flow through the valve assembly.

15. The system of claim 14, wherein the central control unit is configured to generate an alert if abnormal gas flow is detected.

16. A gas appliance control system, the system comprising:
a valve assembly configured to regulate gas flow to a gas appliance;
a user interface device configured to transmit gas flow requests; and
a central control unit operatively connected to the valve assembly and the user interface device, the central control unit configured to:
receive a gas flow request from the user interface device,
determine whether the gas flow request is authorized, and
control the valve assembly to regulate gas flow to the gas appliance based on the determination.

17.-27.(canceled)

28. The system of claim 16, further comprising a wired control switch connected to the central control unit.

29. (canceled)

30. The system of claim 16, wherein the central control unit comprises a memory configured to store user preferences for gas flow control.

31. The system of claim 16, wherein the central control unit comprises a memory configured to log gas flow control actions.

32. The system of claim 16, wherein the central control unit is configured to provide feedback to the user interface device regarding the current flow state of the valve assembly.
